(19) United States
(12) Patent Application Publication
(10) Pub. No.: US 2014/0108512 A1
(43) Pub. Date: Apr. 17, 2014

(54) METHOD AND DEVICE FOR ACCESSING WEB PAGES

(71) Applicant: TENCENT TECHNOLOGY (SHENZHEN) COMPANY LIMITED, Shenzhen City (CN)

(72) Inventors: LIANGLIANG GUAN, Shenzhen City (CN); XUEMIN MA, Shenzhen City (CN); JINGYU YANG, Shenzhen City (CN); LIN DU, Shenzhen City (CN)

(73) Assignee: TENCENT TECHNOLOGY (SHENZHEN) COMPANY LIMITED, Shenzhen City (CN)

(21) Appl. No.: 14/106,543

(22) Filed: Dec. 13, 2013

Related U.S. Application Data
(63) Continuation of application No. PCT/CN2012/080113, filed on Aug. 14, 2012.

(30) Foreign Application Priority Data
Nov. 15, 2011 (CN) 201110360578.4

(51) Int. Cl. H04L 29/08

(52) U.S. Cl. CPC H04L 67/2847; H04L 67/02
USPC 709/203

(57) ABSTRACT

A method and a device for accessing web pages are disclosed. The method includes: preloading a corresponding uniform resource locator (URL) according to URL information which needs to be preloaded and is configured in a configuration file, and caching obtained web page information; and judging whether a client device has cached the web page information corresponding to the URL according to the URL carried in a web page access request when a user sends the web page access request through the client device. The client device includes a preloading module, a caching module, and a judging module. The embodiments of the present invention improve the efficiency of accessing web pages.

### CROSS-REFERENCE TO RELATED APPLICATIONS

This application is a continuation of International Application No. PCT/CN2012/080113, filed on Aug. 14, 2012, which claims priority to Chinese Patent Application No. 201110360578.4, filed on Nov. 15, 2011, both of which are hereby incorporated by reference in their entireties.

### FIELD OF THE TECHNOLOGY

The present invention relates to communication technology field, and in particular, to a method and a device for accessing web pages.

### BACKGROUND OF THE INVENTION

With rapid development of Internet technology, Web has become a main source to obtain information. By accessing web pages, people can obtain miscellaneous information required in daily work and life. However, on the one hand, the amount of information included in the web page is increasing, the modes of presenting web pages are diversified, and the amount of information that needs to be downloaded from a server increases when the user needs to access a web page, which accordingly leads to increase of time consumed in accessing a web page. On the other hand, when accessing a web page, if all information required is obtained from the server, users will have worse experience due to delay in accessing the web page, when the web site is accessed by many users at a time, namely, when the accessing amount of the web site is large. Therefore, there is urgent need to improve the efficiency of accessing web pages.

### SUMMARY OF THE INVENTION

The present invention provides a method and device for accessing web pages to improve efficiency of accessing the web pages. The following technical solutions are put forward in the embodiments of the present invention.

A method for accessing web pages includes:

preloading, by a client device, a corresponding uniform resource locator (URL) according to URL information which needs to be preloaded and is configured in a configuration file, obtaining web page information corresponding to the URL and caching obtained web page information; and

when a user sends, through the client device, a web page access request carrying a URL, judging whether the client device has cached the web page information corresponding to the URL according to the URL carried in the web page access request.

A client device includes:

a preloading module, configured to preload a corresponding uniform resource locator (URL) according to URL information which needs to be preloaded and is configured in a configuration file;

a caching module, configured to obtain web page information corresponding to the URL and cache web page information obtained by the preloading module preloading the URL; and

a judging module, configured to when a user sends, through the client device, a web page access request carrying a URL, judge whether the caching module has cached the web page information corresponding to the URL according to the URL carried in the web page access request.

A machine-readable medium is provided, which stores an instruction set. When the instruction set is executed, the machine can execute the foregoing method.

Compared with the prior art, the embodiments of the present invention bring at least the following benefits:

In the embodiments of the present invention, the client device preloads the URL, and caches the obtained web page information; when the user accesses the web page corresponding to the URL through the client device, if the client device has cached the web page information corresponding to the URL, the client device may obtain the web page information cached in the client device, and obtain the corresponding web page according to the web page information, thereby improving efficiency of accessing web pages.

### BRIEF DESCRIPTION OF THE DRAWINGS

FIG. 1 is a schematic flowchart of a method for accessing web pages according to an embodiment of the present invention;

FIG. 2 is a schematic structural diagram of a system in a specific application scenario according to an embodiment of the present invention;

FIG. 3 is a schematic flowchart of a method for accessing web pages based on a system architecture shown in FIG. 2 according to an embodiment of the present invention; and

FIG. 4 is schematic structural diagram of a client device according to an embodiment of the present invention.

### DETAILED DESCRIPTION OF THE EMBODIMENTS

To improve the efficiency of accessing web pages, embodiments of the present invention provide a technical solution to accessing web pages. A client device loads a corresponding Uniform Resource Locator (URL) according to URL information which needs to be preloaded, and caches obtained web page information; the client device judges whether the client device has cached the web page information corresponding to the URL according to the URL carried in a web page access request when a user sends the web page access request through the client device; and if the client device has cached the corresponding web page information, the client device obtains the corresponding web page information, thereby improving the efficiency of accessing web pages.

Wherein the client devices loading the corresponding URL according to the URL information which needs to be preloaded may specifically include: the client device obtains source codes of the web page corresponding to the URL.

The following describes the technical solution of embodiments of the present invention in detail with reference to accompanying drawings.

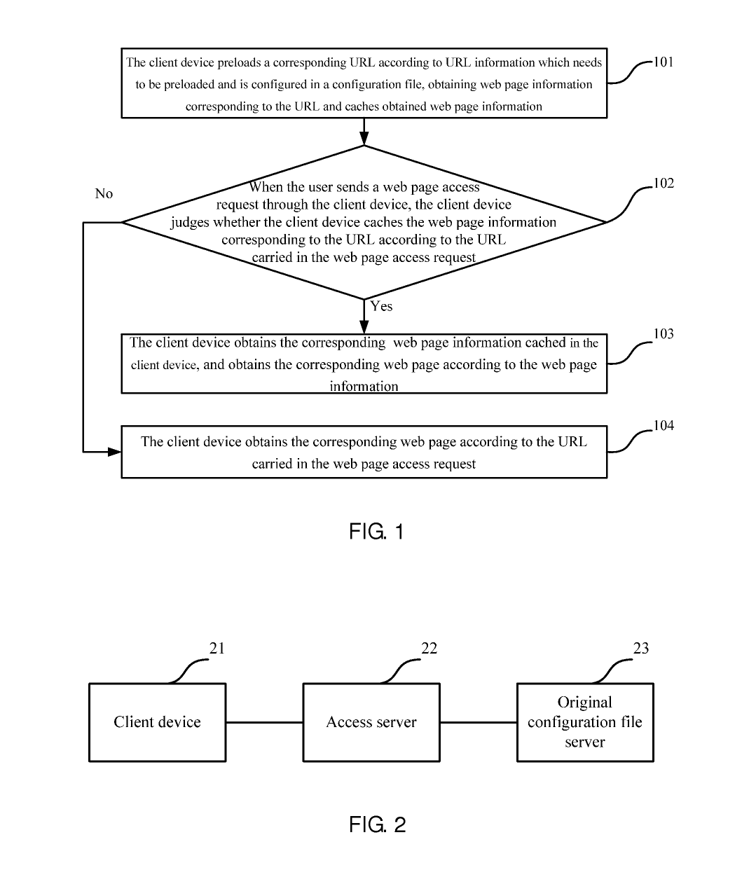

FIG. 1 is a schematic flowchart of a method for accessing web pages according to an embodiment of the present invention. The method for accessing web pages provided in this embodiment may be stored as a computer program in a machine-readable medium such as an optical disk. The method for accessing web pages may include the following steps:

Step 101: The client device preloads a corresponding URL according to URL information which needs to be preloaded and is configured in a configuration file, obtaining web page information corresponding to the URL and caches obtained web page information.

Specifically, in the technical solution provided in this embodiment of the present invention, the URL information which needs to be preloaded by the client device may be configured by the user in the configuration file of the client device directly, or may be obtained by the client device from a server.

The URL information which needs to be preloaded may be configured by the user in the configuration file of the client device directly. Specifically, when running for the first time, the client device may obtain the URL information which needs to be preloaded and is configured in the configuration file, preload the corresponding URL, obtain web page information corresponding to the URL and cache the obtained web page information.

Alternatively, the URL information which needs to be preloaded may be obtained by the client from the server. Specifically, when the client device runs for the first time, or when the preset update period expires, the client device may send a configuration file obtaining request to the server to obtain the configuration file in which the URL information which needs to be preloaded is configured, preload the corresponding URL according to the obtained URL information which needs to be preloaded, and cache the obtained web page information. Correspondingly, the client device may record the time of obtaining the URL information which needs to be preloaded from the server, and, in the running process, check whether time difference between the current time and the previous time of obtaining the URL information reaches a preset update period (such as 12 hours). If the time difference reaches the preset update period, the client device sends a configuration file obtaining request to the server again, preloads the corresponding URL according to the obtained URL information which needs to be preloaded, and updates the previously cached web page information with the obtained web page information.

If the URL information which needs to be preloaded is obtained by the client device from the server, the detailed implementation may also be: the server periodically sends to the client device a configuration file in which the URL information which needs to be preloaded is configured to the client device; or, when the URL information which needs to be preloaded and is stored in the server is updated, the server sends a configuration file in which the URL information which needs to be preloaded is configured to the client device. Upon receiving the configuration file sent by the server, the client device preloads the corresponding URL according to the URL information which needs to be preloaded and is configured in the configuration file.

It should be noted that while the user configures the URL information which needs to be preloaded, the client device may obtain the URL information which needs to be preloaded from the server at the same time. For example, when the client device runs for the first time, the client device may obtain the locally configured URL information which needs to be preloaded, and preload the corresponding URL; or, when the preset update period expires, the client device obtains the URL information which needs to be preloaded from the server, and preloads the corresponding URL to update the cached web page information.

Step 102: When the user sends a web page access request through the client device, the client device judges whether the client device has cached the web page information corresponding to the URL according to the URL carried in the web page access request. If the judging result is positive, proceed to step 103; otherwise, proceed to step 104.

Specifically, when the user sends the web page access request through the client device (for example, the client device receives the URL input by the user and the access request), the client device may judge whether the client device has cached the web page information corresponding to the URL according to the URL carried in the web page access request. If the client device has cached the corresponding web page information, the client device can obtain the web page which needs to be accessed according to the web page information; otherwise, the client device needs to obtain the corresponding web page from the server according to the URL carried in the web page access request.

Step 103: The client device obtains the corresponding web page information cached in the client device, and obtains the corresponding web page according to the web page information.

Specifically, after obtaining the web page information cached in the client device, the client device may judge whether the web page information is updated (namely, whether the web page information cached in the client device is consistent with the web page information of the equivalent URL in the server). If no update occurs, the client device may obtain the corresponding web page by loading the corresponding web page information; if update has occurred, the client device may obtain the corresponding web page according to the URL carried in the web page access request.

Step 104: The client device obtains the corresponding web page according to the URL carried in the web page access request.

It can be seen from the above description, in the technical solution of embodiments of the present invention, the client device preloads the URL, and caches the obtained web page information; when the user accesses the web page corresponding to the URL through the client device, the client device can obtain the corresponding web page information cached in the client device, and obtain the corresponding web page according to the web page information, thereby improving efficiency of accessing web pages.

The following describes the technical solution of embodiments of the present invention in more detail with reference to a specific application scenario.

FIG. 2 is a schematic structural diagram of a system in a specific application scenario according to an embodiment of the present invention. The system includes a client device 21, an access server 22, and an original configuration file server 23.

The original configuration file server 23 is configured to store the URL information which needs to be preloaded. The URL information may be configured in the original configuration file server 23, such as URL of a QQ space homepage, URL of Sina homepage. The URL information may be configured by an operator according to actual conditions.

The access server 22 may obtain the URL information which needs to be preloaded from the original configuration file server 23 at preset intervals (such as 10 minutes). After obtaining the URL information which needs to be preloaded, the access server 22 may encrypt the obtained information.

The client device 21 interacts with the access server 22 to obtain the URL information which needs to be preloaded. When the URL information obtained by the client device 21 is encrypted URL information, the client device 21 needs to decrypt the URL information. Correspondingly, the corresponding encryption and decryption algorithms may be negotiated between the client device 21 and the access server 22 beforehand.

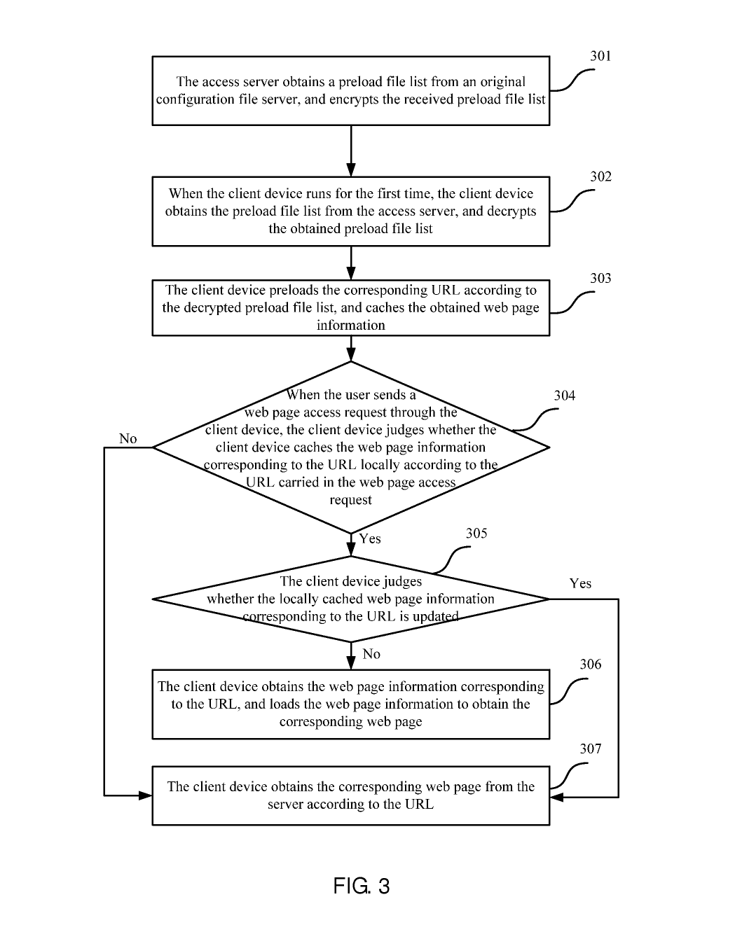

Based on the system architecture above, an embodiment of the present invention provides a method for accessing web pages. In this embodiment of the present invention, the client device accesses the web page through a browser. The method for accessing web pages provided in this embodiment may be stored as a computer program in a machine-readable medium such as optical disk. As shown in FIG. 3, the method may include the following steps:

Step 301: The access server obtains a preload file list from an original configuration file server, and encrypts the received preload file list.

The access server may send a preload file list obtaining request to the original configuration file server every 5 minutes to obtain the URL information which needs to be preloaded, and update the preload file list stored in the client device according to the obtained file list. After receiving the preload file list obtaining request sent by the access server, the original configuration file server may judge whether the locally stored URL information which needs to be preloaded is updated against the previously received obtaining request. If the URL information is updated, the original configuration file server returns the preload file list to the access server; otherwise, the original configuration file server does not need to respond to the obtaining request. Correspondingly, the original configuration file server needs to record the timestamp of receiving the preload file list obtaining request.

To improve security of the file list, after obtaining the preload file list, the access server may use the encryption algorithm pre-negotiated with the client device to encrypt the preload file list.

Step 302: When the client device runs for the first time, the client device obtains the preload file list from the access server, and decrypts the obtained preload file list.

Specifically, when the client device runs for the first time, the client device may send the preload file list obtaining request to the access server to obtain the URL information which needs to be preloaded. After obtaining the preload file list, the client device may use the decryption algorithm pre-negotiated with the access server to decrypt the preload file list.

Step 303: The client device preloads the corresponding URL according to the decrypted preload file list, and caches the obtained web page information.

For example, the URL information included in the decrypted preload file list can be http://sina.com.cn, http://qqzone.com, or http://hao.360.cn. The client device preloads the corresponding URL through the browser, and caches the obtained web page information (such as source codes of the web page). When the browser includes multiple kernels such as Trident, Webkit, and Gecko, the browser may use different kernels to preload the corresponding URL, and store the obtained web page information into the cache corresponding to each kernel. For example, when the web pages corresponding to some URLs only support the IE browser (Trident kernel), the browser needs to preload the corresponding URL through the Trident kernel, and store the obtained web page information into IE cache.

Step 304: When the user sends a web page access request through the client device, the client device judges whether the client device has cached the web page information corresponding to the URL according to the URL carried in the web page access request. If the judging result is positive, proceed to step 305; otherwise, proceed to step 307.

Specifically, the user may send the web page access request by inputting the URL into an address input box of the client device. The client device may check whether the web page information corresponding to the URL is cached according to the URL carried in the web page access request. If the client device has not cached the web page information corresponding to the URL, the client device needs to obtain the corresponding web page from the server according to the URL.

Step 305: The client device judges whether the locally cached web page information corresponding to the URL is updated. If the judging result is positive, proceed to step 307; otherwise, proceed to step 306.

Specifically, if the client device has cached the web page information corresponding to the URL carried in the web page access request, the client device further judges whether the web page information corresponding to the URL is updated, namely, whether the locally cached web page information corresponding to the URL is consistent with the web page information corresponding to the URL stored on the network side. If no update occurs (the web page information is consistent with that stored on the network side), the client device may obtain the corresponding web page by loading the corresponding cached web page information; otherwise, the client device needs to obtain the corresponding web page from the server according to the URL carried in the web page access request.

Step 306: The client device obtains the web page information corresponding to the URL, and loads the web page information to obtain the corresponding web page.

Step 307: The client device obtains the corresponding web page from the server according to the URL.

It can be seen from the above procedure that, in this embodiment, the client device makes full use of the cache protocol, preloads the URL through a browser, and caches the obtained web page information; when the user needs to access the web page corresponding to the corresponding URL, the access can be implemented through the cache, which improves the speed of accessing web pages.

The technical solution of embodiments of the present invention will be described below in combination with a specific instance. In this embodiment, it will be described by accessing a QQ space through a multi-core browser (such as QQ browser). The original configuration file server is a space server. The access server can periodically obtain the URL information which needs to be preloaded from the space server.

When the user runs the QQ browser for the first time, the QQ browser may be triggered to send a preload file list obtaining request to the access server to obtain the URL information which needs to be preloaded. (If the obtained preload file list is an encrypted file, the obtained file needs to be decrypted according to the decryption algorithm negotiated beforehand). After obtaining the preload file list, the QQ browser preloads the corresponding URL (such as http://qqzone.com), and caches the obtained web page information. (The QQ browser includes the IE kernel and the Webkit kernel. The user may choose the IE kernel or the Webkit kernel at the user's discretion to run the QQ browser. Correspondingly, the web page information obtained through the preloading is cached in the IE cache or Webkit cache.) When the user accesses the QQ space through the QQ browser (by inputting http://qqzone.com in the address input field of the browser), the QQ browser obtains the cached web page information corresponding to the URL, and loads the obtained web page information to obtain the home page of the QQ space. As the browser can directly load the corresponding web page information in the cache without having to obtain the web page information corresponding to the URL from the server, thereby improving efficiency of accessing web pages.

Based on the same technical conception as the method embodiment above, an embodiment of the present invention provides a client device, which is applicable to a system which includes a client device and a server.

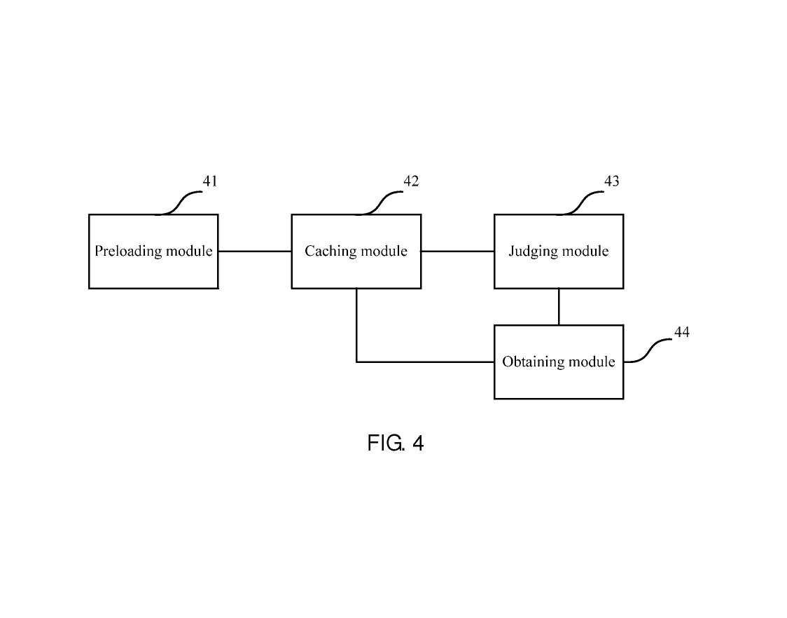

FIG. 4 is schematic structural diagram of a client device according to this embodiment of the present invention. The client device may include:

a preloading module 41, configured to preload a corresponding URL according to URL information which needs to be preloaded and is configured in a configuration file;

a caching module 42, configured to cache web page information obtained when the preloading module 41 preloads the URL; and

a judging module 43, configured to judge whether the caching module 41 has cached the web page information corresponding to the URL according to the URL carried in a web page access request when a user sends the web page access request through the client device.

The client device may further include:

an obtaining module 44, configured to obtain the web page information cached in the caching module 42 when the judging result of the judging module 43 is positive, and obtain the corresponding web page according to the obtained web page information.

Specifically, the preloading module 41 is specifically configured to preload the corresponding URL by using different kernels according to the URL information which needs to be preloaded and is configured in the configuration file. The caching module 42 is specifically configured to store the web page information obtained by the preloading module 41 preloading the URL in the cache corresponding to the kernels.

The configuration file is obtained by the client device from the server.

The preloading module 41 is specifically configured to: at the first time of running, or when the preset update period expires, send a configuration file obtaining request to the server to obtain the URL information which needs to be preloaded, and preload the corresponding URL according to the obtained URL information to be preloaded. More specifically, the preloading module 41 is specifically configured to record the time of previously obtaining the URL information which needs to be preloaded from the server; check whether time difference between the current time and the time of previously obtaining the URL information reaches a preset update period; if the time difference reaches the preset update period, send a configuration file obtaining request to the server to obtain the URL information which needs to be preloaded.

Alternatively, the preloading module 41 is specifically configured to receive a configuration file sent by the server, and load the corresponding URL according to the URL information which needs to be preloaded and is configured in the configuration file; wherein the server periodically sends a configuration file in which the URL information to be preloaded is configured to the client device; or, when the URL information which needs to be preloaded is updated, the server sends the configuration file in which the URL information to be preloaded is configured to the client device.

The configuration file is configured by the user in the client device.

The preloading module 41 is specifically configured to obtain the URL information which needs to be preloaded when the client device runs for the first time, and preload the corresponding URL.

The server includes an access server and an original configuration file server. The original configuration file server stores the URL information which needs to be preloaded, and the access server periodically obtains the URL information which needs to be preloaded from the original configuration file server.

The configuration file is obtained from the server. Specifically, the configuration file is obtained by the client device from the access server.

The judging module 43 is further configured to judge whether the web page information obtained by the obtaining module 44 is updated.

The obtaining module 44 is specifically configured to load the web page information to obtain the corresponding web page, if the judging module 43 determines that the web page information obtained by the obtaining module 44 is not updated; obtain the corresponding web page from the server according to the URL, if the judging module 43 determines that the caching module 42 has not cached the web page corresponding to the URL carried in the web page access request, or the judging module 43 determines that the web page information obtained by the obtaining module 44 is updated.

According to the descriptions of the above embodiments, those skilled in the art understand that the present invention may be implemented by hardware only, or preferably in most circumstances, by software and a universal hardware platform. Therefore, the technical solution of the present invention or contribution to the prior art may be embodied in a software product. The software product may be stored in storage media and incorporates several instructions causing a computer device (for example, personal computer, server, or network device) to execute the method specified in any embodiment of the present invention.

Those skilled in the art should understand that the accompanying drawings are only schematic diagrams of preferred embodiments, and the modules or procedures illustrated in the accompanying drawings are not mandatory for implementing the present invention.

Those skilled in the art should understand that the modules in an apparatus provided in an embodiment of the present invention may be distributed in the apparatus in the way described herein, or may be located in one or more apparatuses in a different way. The modules may be combined into one, or split into submodules.

The above descriptions are merely preferred embodiments of the present invention, but not intended to limit the scope of the present invention. Any modifications or variations that can be derived by those skilled in the art shall fall within the scope of the present invention.

What is claimed is:

1. A method for accessing web pages, comprising:
preloading, by a client device, a corresponding uniform resource locator (URL) according to URL information which needs to be preloaded and is configured in a configuration file, obtaining web page information corresponding to the URL and caching obtained web page information; and
when a user sends, through the client device, a web page access request carrying a URL, judging whether the client device has cached the web page information corresponding to the URL according to the URL carried in the web page access request.

2. The method according to claim 1, further comprising:
obtaining the web page information cached in the client device if it is determined that the client device has cached the web page information corresponding to the URL, and obtaining a corresponding web page according to the web page information.

3. The method according to claim 1, wherein:
the configuration file is obtained by the client device from a server;
the preloading, by the client device, the corresponding URL according to the URL information which needs to be preloaded and is configured in the configuration file comprises:
sending, by the client device, a configuration file obtaining request to the server to obtain the URL information which needs to be preloaded when the client device runs for a first time, or when a preset update period expires, and preloading, by the client device, the corresponding URL according to the obtained URL information which needs to be preloaded; or
receiving, by the client device, a configuration file sent by the server, and loading the corresponding URL according to the URL information which needs to be preloaded and is configured in the configuration file, wherein the configuration file is sent by the server to the client device periodically or upon update of the URL information which needs to be preloaded, and the URL information which needs to be preloaded is configured in the configuration file.

4. The method according to claim 1, wherein:
the configuration file is configured in the client device by the user;
the preloading, by the client device, the corresponding URL according to the URL information which needs to be preloaded and is configured in the configuration file comprises:
obtaining, by the client device, the URL information which needs to be preloaded when the client device runs for a first time, and preloading, by the client device, the corresponding URL.

5. The method according to claim 3, wherein:
the server comprises an access server and an original configuration file server, and the original configuration file server stores the URL information which needs to be preloaded;
the method further comprises: obtaining, by the access server, the URL information which needs to be preloaded from the original configuration file server periodically;
the configuration file is the configuration file sent by the access server to the client device periodically or upon update of the URL information which needs to be preloaded.

6. The method according to claim 2, wherein:
the obtaining the corresponding web page according to the web page information comprises:
judging whether the web page information is updated, and loading the web page information to obtain the corresponding web page if the judging result is negative;
the method further comprises:
obtaining the corresponding web page from the server according to the URL, if it is determined that the client device has not cached the web page information corresponding to the URL carried in the web page access request or that the web page information is updated.

7. The method according to claim 3, wherein:
the sending the configuration file obtaining request to the server to obtain the URL information which needs to be preloaded when the preset update period expires comprises:
recording time of previously obtaining the URL information which needs to be preloaded from the server;
checking whether a time difference between current time and time of previously obtaining the URL information reaches a preset update period; and sending a configuration file obtaining request to the server to obtain the URL information which needs to be preloaded if the difference reaches the preset update period.

8. The method according to claim 5, further comprising:
encrypting, by the access server, the obtained URL information which needs to be preloaded according to a pre-negotiated encryption algorithm;
decrypting, by the client device, the obtained URL information which needs to be preloaded according to a pre-negotiated decryption algorithm.

9. The method according to claim 1, wherein:
the preloading, by the client device, the corresponding URL, obtaining web page information corresponding to the URL and caching the obtained web page information comprises:
preloading, by the client device, each corresponding URL using a different kernel, obtaining web page information corresponding to the URL and storing the obtained web page information in a cache corresponding to the kernel.

10. A client device, comprising:
a preloading module, configured to preload a corresponding uniform resource locator (URL) according to URL information which needs to be preloaded and is configured in a configuration file;
a caching module, configured to obtain web page information corresponding to the URL and cache web page information obtained by the preloading module preloading the URL; and
a judging module, configured to when a user sends, through the client device, a web page access request carrying a URL, judge whether the caching module has cached the web page information corresponding to the URL according to the URL carried in the web page access request.

11. The client device according to claim 10, further comprising:
an obtaining module, configured to obtain the web page information cached in the caching module when a judging result of the judging module is positive, and obtain a corresponding web page according to the web page information.

12. The client device according to claim 10, wherein:
the configuration file is obtained by the client device from a server;
the preloading module is configured to send a configuration file obtaining request to the server to obtain the URL information which needs to be preloaded when the client device runs for a first time, or when a preset update period expires, and preload the corresponding URL according to the obtained URL information which needs to be preloaded; or
the preloading module is configured to receive a configuration file sent by the server, and load the corresponding URL according to the URL information which needs to be preloaded and is configured in the configuration file, wherein the configuration file is sent by the server to the client device periodically or upon update of the URL information which needs to be preloaded, and the URL information which needs to be preloaded is configured in the configuration file.

13. The client device according to claim 10, wherein:
the configuration file is configured in the client device by the user; and
the preloading module is configured to obtain the URL information which needs to be preloaded when the client device runs for the first time, and preload the corresponding URL.

14. The client device according to claim 12, wherein:
the server comprises an access server and an original configuration file server; the original configuration file server stores the URL information which needs to be preloaded, and the access server obtains the URL information which needs to be preloaded from the original configuration file server periodically; and
the configuration file is the configuration file sent by the access server to the client device periodically or upon update of the URL information which needs to be preloaded.

15. The client device according to claim 11, wherein:
the judging module is further configured to judge whether the web page information obtained by the obtaining module is updated; and
the obtaining module is configured to load the web page information to obtain the corresponding web page, if the judging module determines that the web page information obtained by the obtaining module is not updated; and obtain the corresponding web page from the server according to the URL, if the judging module determines that the caching module has not cached the web page corresponding to the URL carried in the web page access request, or the judging module determines that the web page information obtained by the obtaining module is updated.

16. The client device according to claim 12, wherein:
the preloading module is configured to record time of previously obtaining the URL information which needs to be preloaded from the server; check whether a time difference between current time and time of previously obtaining the URL information reaches a preset update period; and send a configuration file obtaining request to the server to obtain the URL information which needs to be preloaded if the difference reaches the preset update period.

17. The client device according to claim 10, wherein:
the preloading module is configured to preload the corresponding URL using different kernels according to the URL information which needs to be preloaded and is configured in the configuration file; and
the caching module is configured to store the web page information obtained by the preloading module preloading the URL.

18. A machine-readable medium, which stores an instruction set; when the instruction set is executed, a machine executes a method specified in claim 1.
